(19) United States
(12) Patent Application Publication
(10) Pub. No.: US 2015/0355340 A1
(43) Pub. Date: Dec. 10, 2015

(54) CO-LOCATED ANTENNA

(71) Applicant: LEICA GEOSYSTEMS AG, Heerbrugg (CH)

(72) Inventor: Brendon Troy LILLY, Dutton Park (AU)

(21) Appl. No.: 14/762,445

(22) PCT Filed: Jan. 17, 2014
(86) PCT No.: PCT/EP2014/050877

§ 371 Date: Jul. 21, 2015

(30) Foreign Application Priority Data
Jan. 21, 2013 (AU) 2013900234

(51) Int. Cl. G01S 19/43; G01S 19/42; H01Q 25/04

(52) U.S. Cl. CPC G01S 19/43; H01Q 25/04; G01S 19/42

(57) ABSTRACT

A co-located global navigation satellite system (GNSS) antenna (40) and beamforming antenna (20), where the phase centres of the two antennae are co-located in at least one axis, preferably the vertical axis. Differences in the phase centre locations can be compensated using, for example, orientation and/or sensor data.

### FIELD OF THE INVENTION

The invention relates to a co-located antenna. In particular, the invention relates, but is not limited, to a co-located beamforming and global navigation satellite system (GNSS) antenna.

### BACKGROUND TO THE INVENTION

Reference to background art herein is not to be construed as an admission that such art constitutes common general knowledge in Australia or elsewhere.

The use of global navigation satellite systems (GNSS), such as GPS and GLONASS, to determine the position of objects around the Earth, primarily on the surface of the Earth, are well known. Satellite receivers use signals from the satellites to determine their location, usually to within a few metres accuracy. However, line of site is required with the satellites and if GNSS signals are obstructed, for example by tall structures such as terrain or buildings, positioning performance is degraded. In particularly obstructed situations, such as when the receiver is indoors, positioning capability is typically lost altogether.

In areas of known GNSS obstruction a ground based pseudo-satellite, known as a ‘pseudolite’, may be used to provide a ground based transceiver at a visible location. However, pseudolites suffer from many drawbacks including difficulties in placement, integrating GNSS and pseudolite systems together so that they do not interfere with each other, and errors introduced due to signal reflections or the like. In an indoor environment, the ceiling, floor, and walls provide numerous surfaces for interference and reflection and multipath errors result in significant range determination errors from the pseudolite.

### OBJECT OF THE INVENTION

It is an aim of this invention to provide a co-located antenna which overcomes or ameliorates one or more of the disadvantages or problems described above, or which at least provides a useful alternative.

Other preferred objects of the present invention will become apparent from the following description.

### SUMMARY OF INVENTION

According to a first aspect of the invention, there is provided a co-located antenna comprising:

a global navigation satellite system (GNSS) antenna having a GNSS antenna phase centre; and
a beamforming antenna having a beamforming antenna phase centre;

wherein the GNSS antenna phase centre and the beamforming antenna phase centre are co-located in at least one axis.

Preferably the GNSS and beamforming antenna are co-located in two axes, preferably co-located in two horizontal axes that form a horizontal plane. Preferably any offset of the phase centres is predetermined. The co-located antenna preferably further comprises an antenna receiver.

The co-located antenna, preferably the antenna receiver of the co-located antenna, preferably compensates for any offset between the GNSS antenna phase centre and the beamforming antenna phase centre. Preferably the co-located antenna compensates for differences in an axis, preferably differences in the vertical axis, to provide effective co-location of the phase centres in all axes.

The beamforming antenna preferably provides orientation data including pitch, roll, and attitude of the antenna. Differences in an axis, preferably differences in the vertical axis, are preferably compensated using the orientation data. Alternatively, or additionally, the co-located antenna may further comprise one or more sensors and differences in an axis are preferably compensated using data from the one or more sensors.

Preferably the beamforming antenna is a substantially hemispherical or spherical antenna. Preferably the GNSS antenna is a patch antenna. Preferably the GNSS antenna is located on a surface of the beamforming antenna. Preferably the GNSS antenna is located on an upper region of the beamforming antenna, even more preferably on an uppermost surface of the beamforming antenna. Preferably the phase centres of the GNSS antenna and beamforming antenna are aligned along a vertical axis.

Preferably the GNSS antenna and the beamforming antenna are both located in an antenna housing. The GNSS antenna is preferably mounted to the beamforming antenna, and may be fixedly or releasably mounted. Alternatively, the GNSS antenna and beamforming antenna may be formed integrally with each other.

Preferably the GNSS antenna and the beamforming antenna each have a separate signal connector in the housing. Preferably the signal connector is a radio frequency (RF) connector. Preferably the GNSS antenna and the beamforming antenna are each in communication with an antenna receiver, preferably via respective RF connectors.

The antenna receiver is preferably a combined GNSS and beamforming positioning receiver. Preferably the antenna receiver processes signals from one or both of GNSS and beamforming antennae to determine a position of the receiver.

According to a second aspect of the invention, there is provided a method of determining a position estimate of a co-located antenna in communication with a receiver, the method comprising the steps of:

determining whether a global navigation satellite system (GNSS) is available to communicate with the receiver;

receiving a GNSS signal from the global navigation satellite system (GNSS) using a GNSS antenna of the co-located antenna if the GNSS system is determined to be available;

determining whether a terrestrial positioning system is available to communicate with the receiver;

receiving a terrestrial signal from the terrestrial positioning system using a beamforming antenna co-located with the GNSS antenna if the terrestrial positioning system is determined to be available; and

processing the GNSS signal if determined to be available and the terrestrial signal if determined to be available with the receiver; and

determining a position estimate of the co-located antenna using the GNSS signal if it is determined to be available and using the terrestrial signal if it is determined to be available.

The step of processing the GNSS signal if determined to be available and the terrestrial signal if determined to be available with the receiver preferably further comprises the step of compensating for an offset between the GNSS antenna phase centre and the beamforming antenna phase centre. Preferably the beamforming antenna provides orientation data, preferably including pitch, roll, and attitude of the antenna, and the orientation data is utilised to compensate for the offset between the GNSS antenna phase centre and the beamforming antenna phase centre.

Further features and advantages of the present invention will become apparent from the following detailed description.

### BRIEF DESCRIPTION OF THE DRAWINGS

By way of example only, preferred embodiments of the invention will be described more fully hereinafter with reference to the accompanying figures, wherein:

FIG. 1 is a perspective view of a co-located GNSS and hemispherical beamforming antenna according to an embodiment of the invention;

FIG. 2 is a perspective view of a co-located GNSS and spherical beamforming antenna according to an embodiment of the invention;

FIG. 3 is a diagrammatic view of a co-located antenna according to an embodiment of the invention;

FIG. 4 is a flow chart illustrating steps of a method according to an embodiment of the invention; and

FIG. 5 is a diagrammatic view of the invention in use in an urban environment.

### DETAILED DESCRIPTION OF THE DRAWINGS

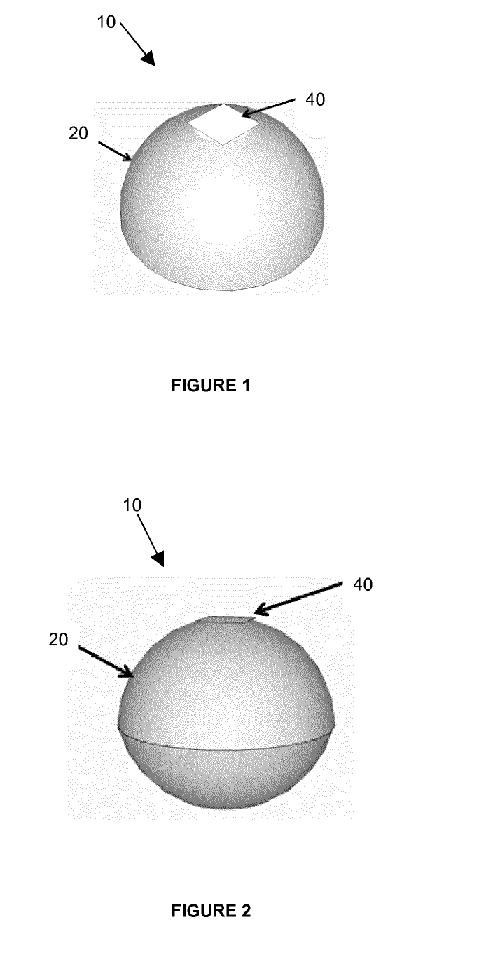

FIG. 1 illustrates a co-located antenna 10 including a substantially hemispherical beamforming antenna 20 and a global navigation satellite system (GNSS) antenna in the form of a substantially planar GNSS patch antenna 40. The GNSS patch antenna 40 is located on an uppermost surface of the beamforming antenna 20, with the phase centre of the GNSS patch antenna 40 being co-located with the phase centre of the beamforming antenna 20 in two orthogonal horizontal axes that form a horizontal plane. The phase centres of the two antennae are consequently aligned along the vertical axis but have a vertical offset.

FIG. 2 illustrates a similar co-located antenna 10 but instead of the beamforming antenna 20 being substantially hemispherical it is substantially spherical. Otherwise, the co-located antenna 10 in FIG. 2 is the same as illustrated in FIG. 1. Again, the GNSS patch antenna 40 is located on an uppermost surface of the beamforming antenna 20, with the phase centre of the GNSS patch antenna 40 being co-located with the phase centre of the beamforming antenna 20 in two orthogonal horizontal axes that form a horizontal plane. The phase centres of the two antennae are consequently aligned along the vertical axis but have a vertical offset.

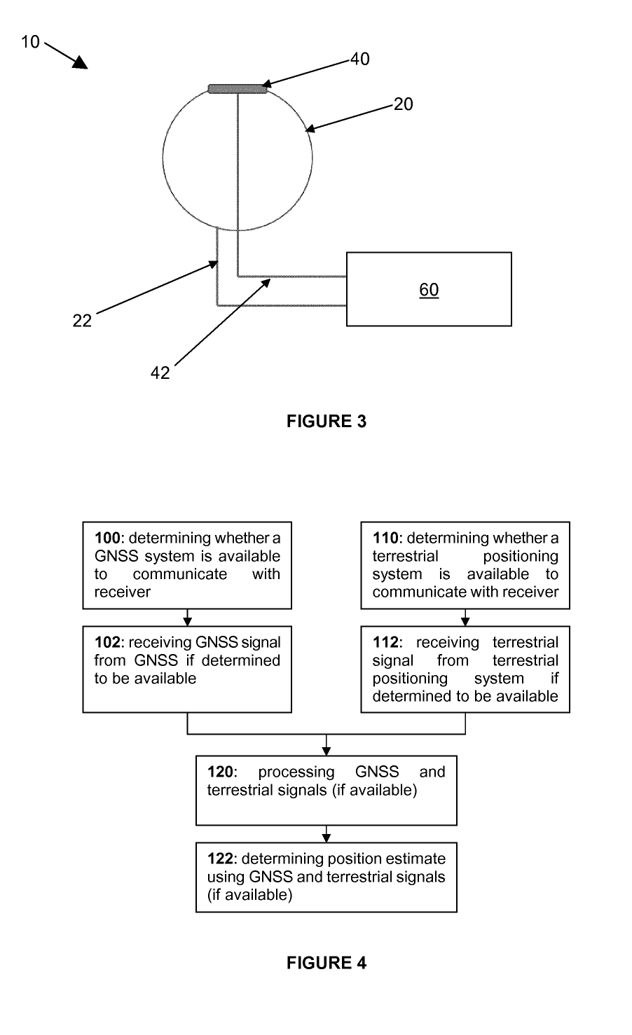

FIG. 3 illustrates a diagrammatic view of a co-located antenna 10 having a beamforming antenna 20 and a GNSS patch antenna 40. The beamforming antenna 20 illustrated in FIG. 3 is substantially spherical, but it will be appreciated that other arrangements, such as a substantially hemispherical antenna as illustrated in FIG. 1, could also be used. The GNSS antenna 40 is again illustrated on an uppermost region of the beamforming antenna 20 which is a preferred, although not required, location for the GNSS antenna 40 relative to the beamforming antenna 20.

The GNSS antenna 40 and beamforming antenna 20 are physically located in the same antenna housing (not shown) but each have a separate radio frequency (RF) connector. Specifically, the beamforming antenna 20 has an RF connector 22 and the GNSS antenna 40 has an RF connector 42. The two RF connectors 22 and 42 are connected to an antenna receiver 60 that is a combined GNSS and terrestrial positioning receiver. The RF connectors 22 and 42 allow the receiver 60 to receive signals from both of the antennae 20, 40.

FIG. 4 illustrates a flow chart illustrating steps of a method of determining a position estimate of a co-located antenna 10 in communication with a receiver 60. The receiver 60 determines whether a GNSS system is available (step 100) and whether a terrestrial positioning system is available (step 110). If the GNSS system is available then a GNSS signal is received (step 102) and if the terrestrial positioning system is available then a terrestrial positioning signal is received (step 112). The signals are then processed (step 120), typically by the receiver 60, and a position estimate is determined using GNSS signal if it was available and using the terrestrial signal if it was available (step 122).

If only one of the GNSS system and the terrestrial positioning system were determined to be available, then the receiver 60 can determine a position estimate using the location using the one available system. If both are available, then the receiver 60 may determine a position estimate using either or both signals, whichever is deemed to provide the highest accuracy and reliability.

In use, the beamforming antenna 20 is able to provide the receiver 60 with orientation data in the form of pitch, roll, and attitude of the receiver which can be used to compensate for the offset in the phase centres of the GNSS antenna 40 and beamforming antenna 20. After compensation the GNSS antenna 40 and beamforming antenna 20 are effectively co-located in both the horizontal plane and the vertical axis.

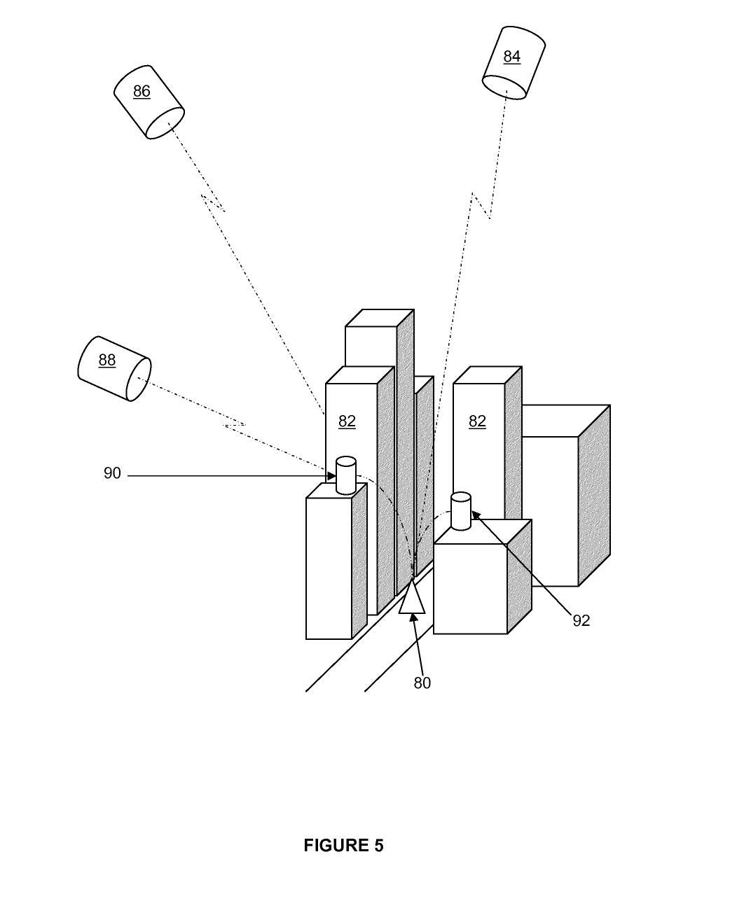

FIG. 5 illustrates an example of the invention in use in an urban environment. Although an urban environment with building obstructions is depicted, no limitation is meant thereby and it will be appreciated that the concepts could equally apply to other environments, such as an outdoor environment with natural obstructions such as mountains or hills, or an indoor environment with wall, door, and window obstructions.

As illustrated in FIG. 5, a device 80, having a co-located antenna 10, is located at or near ground level in an urban canyon of buildings 82. The receiver 60 of the co-located antenna 10 in the device 80 is able to use signals from GNSS and terrestrial positioning systems to determine the location of the device 80, e.g. using the method of FIG. 4.

In the scenario illustrated in FIG. 5, the device 80 has line of sight and with GNSS satellite 84. Device 80 does not have line of site with GNSS satellites 86 and 88 as they are obstructed from view by buildings 82. Additionally, the receiver 60 of the co-located antenna 10 in the device 80 is able to receive signals from terrestrial positioning transmitters 90 and 92 using the beamforming antenna 20. In this situation, the receiver 60 can use either or both of the signals received to determine a position estimate for device 80.

As signals for one system are determined to be available or unavailable, the receiver 60 of the device 80 is able to use signals from the other system to determine the position estimate of the device 80. It is generally envisaged that GNSS will provide better coverage in predominantly open areas where it would be less practical to provide a plurality of terrestrial positioning transmitters, and that terrestrial positioning systems will provide better coverage in predominantly enclosed areas where GNSS is unavailable or unreliable.

Advantageously, the co-located antenna 10 provides a positioning system that is accurate and useful in both open environments and environments with GNSS obstructions. The co-located antenna 10 provides a unitary antenna package for both GNSS and terrestrial positioning systems with the phase centres of the beamforming antenna 20 and GNSS antenna 40 being effectively co-located through physical co-location in at least one axis and compensation for the non-co-located axes.

The beamforming antenna 40 is particularly well suited to enclosed environments, providing high precision in highly multipath environments such as indoors where pseudolites, or the like, are unable to operate effectively. The co-located antenna 10 allows positioning of a device 80 to be determined in a large variety of situations, including those which have traditionally been difficult to provide accurate positioning in. The co-located antenna 10 allows seamless transitions between GNSS and terrestrial positioning systems, continually provide high quality location information regardless of the surrounding environment.

References to phase centres herein also includes apparent phase centres for any antenna with limited or non-spherical electromagnetic radiation patterns.

In this specification, adjectives such as first and second, left and right, top and bottom, and the like may be used solely to distinguish one element or action from another element or action without necessarily requiring or implying any actual such relationship or order. Where the context permits, reference to an integer or a component or step (or the like) is not to be interpreted as being limited to only one of that integer, component, or step, but rather could be one or more of that integer, component, or step etc.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. The invention is intended to embrace all alternatives, modifications, and variations of the present invention that have been discussed herein, and other embodiments that fall within the spirit and scope of the above described invention.

In this specification, the terms ‘comprises’, ‘comprising’, ‘includes’, ‘including’, or similar terms are intended to mean a non-exclusive inclusion, such that a method, system or apparatus that comprises a list of elements does not include those elements solely, but may well include other elements not listed.

1. A co-located antenna comprising:
a global navigation satellite system (GNSS) antenna having a GNSS antenna phase centre; and
a beamforming antenna having a beamforming antenna phase centre;
wherein the GNSS antenna phase centre and the beamforming antenna phase centre are co-located in at least one axis.

2. The co-located antenna of claim 1, wherein the GNSS and beamforming antenna are co-located in two axes.

3. The co-located antenna of claim 2, wherein the GNSS and beamforming antenna are co-located in two horizontal axes that form a horizontal plane.

4. The co-located antenna of claim 1, wherein any offset of the phase centres is predetermined.

5. The co-located antenna of claim 1, further comprising an antenna receiver.

6. The co-located antenna of claim 1, wherein the antenna compensates for any offset between the GNSS antenna phase centre and the beamforming antenna phase centre.

7. The co-located antenna of claim 6, wherein the co-located antenna compensates for differences in an axis to provide effective co-location of the phase centres in all axes.

8. The co-located antenna of claim 7, wherein the co-located antenna compensates for differences in the vertical axis.

9. The co-located antenna of claim 1, wherein the beamforming antenna provides orientation data including pitch, roll, and attitude of the antenna.

10. The co-located antenna of claim 9, wherein differences in an axis between the GNSS antenna phase centre and the beamforming antenna phase centre are compensated using the orientation data.

11. The co-located antenna of claim 1, further comprising one or more sensors, wherein the differences in an axis between the GNSS antenna phase centre and the beamforming antenna phase centre are compensated using the one or more sensors.

12. The co-located antenna of claim 1, wherein the beamforming antenna is a substantially hemispherical or spherical antenna.

13. The co-located antenna of claim 1, wherein the GNSS antenna is a patch antenna.

14. The co-located antenna of claim 1, wherein the GNSS antenna is located on a surface of the beamforming antenna.

15. The co-located antenna of claim 1, wherein the GNSS antenna is located on an upper region of the beamforming antenna.

16. The co-located antenna of claim 15, wherein the GNSS antenna is located on an uppermost surface of the beamforming antenna.

17. The co-located antenna of claim 1, wherein the GNSS antenna and the beamforming antenna are both located in an antenna housing.

18. The co-located antenna of claim 17, wherein the GNSS antenna and the beamforming antenna each have a separate signal connector in the housing.

19. The co-located antenna of claim 18, wherein the GNSS antenna and the beamforming antenna are each in communication with an antenna receiver via respective RF connectors.

20. The co-located antenna of claim 19, wherein the antenna receiver is a combined GNSS and beamforming positioning receiver that processes signals from one or both of the GNSS and beamforming antennae to determine a position of the receiver.

21. A method of determining a position estimate of a co-located antenna in communication with a receiver, the method comprising the steps of:
determining whether a global navigation satellite system (GNSS) is available to communicate with the receiver;
receiving a GNSS signal from the global navigation satellite system (GNSS) using a GNSS antenna of the co-located antenna if the GNSS system is determined to be available;
determining whether a terrestrial positioning system is available to communicate with the receiver;
receiving a terrestrial signal from the terrestrial positioning system using a beamforming antenna co-located with the GNSS antenna if the terrestrial positioning system is determined to be available; and
processing the GNSS signal if determined to be available and the terrestrial signal if determined to be available with the receiver; and
determining a position estimate of the co-located antenna using the GNSS signal if it is determined to be available and using the terrestrial signal if it is determined to be available.

22. The method of claim 21, wherein the step of processing the GNSS signal if determined to be available and the terrestrial signal if determined to be available with the receiver further comprises the step of compensating for an offset between the GNSS antenna phase centre and the beamforming antenna phase centre.

23. The method of claim 22, wherein the beamforming antenna provides orientation data and the step of compensating for the offset between the GNSS antenna phase centre and the beamforming antenna phase centre comprises using the orientation data.
